(19) United States
(12) Patent Application Publication
(10) Pub. No.: US 2022/0310114 A1
(43) Pub. Date: Sep. 29, 2022

(54) SMART AUDIO NOISE REDUCTION SYSTEM

(71) Applicant: DIGILIFE TECHNOLOGIES CO., LTD., Taipei City (TW)

(72) Inventor: CHEN-PING YANG, Taipei City (TW)

(21) Appl. No.: 17/209,265

(22) Filed: Mar. 23, 2021

(51) Int. Cl. G10L 25/84

(52) U.S. Cl. CPC G10L 25/84

(57) ABSTRACT

A smart audio noise reduction system includes sound-receiving units and a smart audio processing unit. The smart audio processing unit receives audio data generated by the sound-receiving units, recognizes, with an artificial intelligence algorithm, voice data being carried in the audio data and falling within a specific ranged of angles, and generates processed digital audio data by optimizing the voice data. Therefore, the smart audio noise reduction system generates a sound stream of definite voice data falling within a specific range of angles to enhance the ease of collecting voice data within a specific range of angles and reduce interference from voice originating from the other locations or ambient sounds.

### BACKGROUND OF THE INVENTION

### 1. Field of the Invention

The present disclosure relates to noise-reduction systems, and in particular to a smart audio noise reduction system capable of recognizing voice audio falling within a specific range of angles.

### 2. Description of the Related Art

Microphone devices convert sounds into electronic signals and thus enable users to increase or decrease the volume and pitch of sounds collected by microphones and mix, edit and adjust the sounds.

The microphone devices, which operate in conjunction with different peripheral devices as needed, are used in indoor conferences, web-based chats, photographs, and scenarios where dash cams are used. Owing to their wide applications, the microphone devices are becoming increasingly popular.

Due to rapid development of video platforms, more and more users are engaged in live streaming and video production, and in consequence the demand for receiving definite voice data is on the rise.

However, in the course of sound reception, microphone devices are unable to recognize ambient sound sources; as a result, in addition to voices, all ambient sounds are received. Consequently, compared with ambient audio, voice data is scant or blurs, resulting in inconvenient voice data collection and thus poor audio quality of sound streams. Prior art discloses an additional directive microphone in an attempt to address the aforesaid drawbacks. However, the directive microphone adds to cost greatly.

### BRIEF SUMMARY OF THE INVENTION

An objective of the present disclosure is to provide a smart audio noise reduction system capable of taking the initiative to recognize voice data in audio data falling within a specific range of angles and optimize the voice data to render it definite, thereby generating a sound stream of the definite voice data falling within a specific range of angles and thus enhancing the ease of collecting voice data falling within a specific range of angles.

To achieve at least the above objective, the present disclosure provides a smart audio noise reduction system comprising: sound-receiving units for receiving audio to generate an audio data; and a smart audio processing unit electrically connected to the sound-receiving units and adapted to receive the audio data, recognize voice data in the audio data with an artificial intelligence algorithm, generate processed digital audio data of the voice data falling within a specific range of angles, and send the processed digital audio data to an electronic device.

In an embodiment, the smart audio processing unit comprises a trained artificial intelligence algorithm for recognizing the voice data of the audio data.

In an embodiment, the smart audio processing unit reduces or deletes audio data outside the specific range of angles according to the identified voice data within the specific range of angles.

In an embodiment, the sound-receiving units are each a digital microphone.

According to the present disclosure, the smart audio processing unit uses the artificial intelligence algorithm to recognize voice data of audio data falling within a specific range of angles and generate processed digital audio data of the optimized voice data falling within the specific range of angles. Therefore, the smart audio noise reduction system of the present disclosure obtains a sound stream of definite voice data falling within a specific range of angles and thus enhances the ease of collecting voice data falling within a specific range of angles.

### BRIEF DESCRIPTION OF THE DRAWINGS

FIG. 1 is a block diagram of a smart audio noise reduction system according to an embodiment of the present disclosure.

FIG. 2 is a schematic view of the operation of the smart audio noise reduction system according to an embodiment of the present disclosure.

FIG. 3 is a schematic view of the configuration of the smart audio noise reduction system according to an embodiment of the present disclosure.

FIG. 4 is another block diagram of the smart audio noise reduction system according to an embodiment of the present disclosure.

FIG. 5 is a schematic view of the operation of the smart audio noise reduction system according to an embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

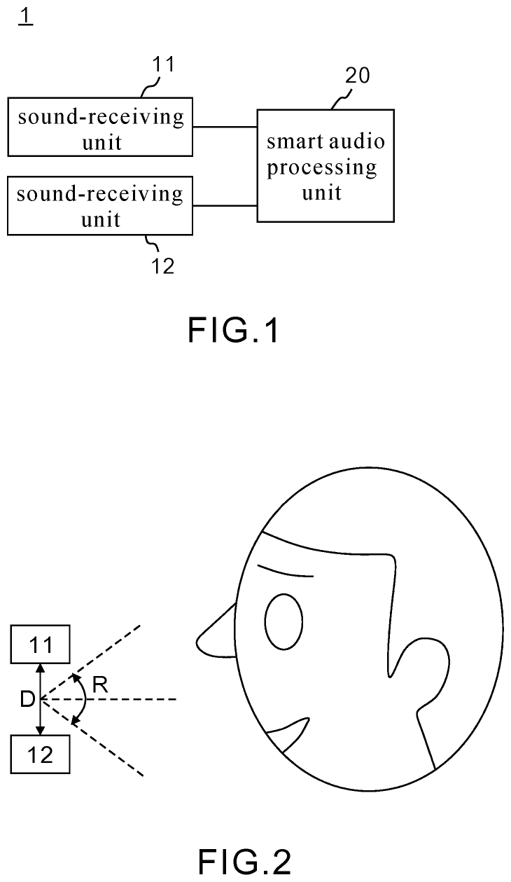

Referring to FIG. 1, in a preferred embodiment of the present disclosure, the smart audio noise reduction system 1 comprises sound-receiving units and a smart audio processing unit 20. In this embodiment, the sound-receiving units are exemplified by a sound-receiving unit 11 and a sound-receiving unit 12, but the sound-receiving units of the present disclosure are not necessarily in the number of two.

The sound-receiving units 11, 12 are electrically connected to the smart audio processing unit 20 to receive sounds and generate an audio data collected at different angles. The audio data comprises ambient sound data and a user's voice data. The smart audio processing unit 20 receives the audio data, recognizes voice data in the audio data with a trained artificial intelligence algorithm, and identifies the angles of the voice data relative to the sound-receiving units 11, 12, so as to separate voice (i.e., voice data not attributed to a user) outside a specific range of angle and voice data (i.e., voice data attributed to the user) within the specific range of angle in the audio data from ambient sound data and generate processed digital audio data by optimizing voice data within the specific range of angles.

Furthermore, the specific range of angles includes the sound-receiving angles formed between the user and the sound-receiving units 11, 12, depends on the distance between the sound-receiving units 11, 12, and includes positive and negative ranges of angles centered at the midpoint of the distance. Referring to FIG. 2, R denotes the specific range of angles, and D denotes the distance between the sound-receiving units 11, 12.

In an embodiment, the distance D is not greater than 10 cm, and the specific range of angles R is not less than −10 degrees ˜+10 degrees, as shown in Table 1 below.

TABLE 1

| distance D | specific range of angle R |
|---|---|
| 5 | −40 ~+ 40 |
| 6 | −35 ~+ 35 |
| 7 | −30 ~+ 30 |
| 8 | −25 ~+ 25 |
| 9 | −20 ~+ 20 |

In an embodiment, the smart audio processing unit 20 reduces or deletes ambient sound data and voice data outside a specific range of angles according to identified ambient sound data and voice data inside the specific range of angles, so as to generate processed digital audio data by optimizing all the sound data within the specific range of angles.

In an embodiment, the sound-receiving units 11, 12 are each, for example, a digital microphone, but the present disclosure is not limited thereto.

In an embodiment, the smart audio processing unit 20 is, for example, a smart audio processing chip, but the present disclosure is not limited thereto.

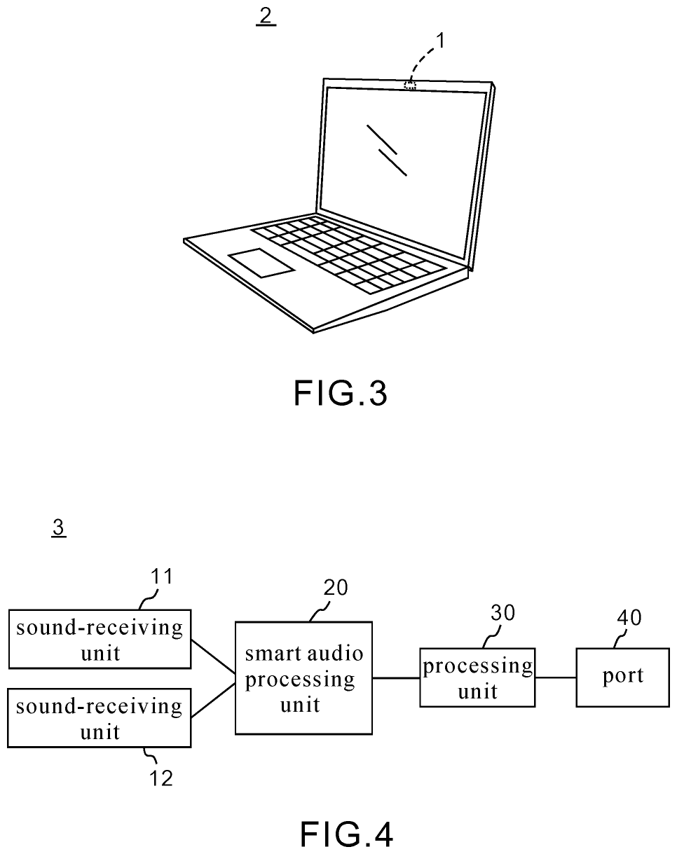

In this embodiment, the smart audio noise reduction system 1 is built-in in an electronic device 2, as shown in FIG. 3. For instance, the smart audio noise reduction system 1 is disposed in the vicinity of a video camera lens, but the present disclosure is not limited thereto.

Therefore, in this embodiment, the smart audio processing unit 20 is electrically connected to a control circuit of the electronic device 2 and provides the processed digital audio data to the control circuit, allowing the user to edit or play the processed digital audio data with the electronic device 2.

Referring to FIG. 4, there is shown another block diagram of the smart audio noise reduction system 3 according to another embodiment of the present disclosure. Unlike the smart audio noise reduction system 1 of FIG. 1, the smart audio noise reduction system 3 of FIG. 4 further comprises a processing unit 30 and a port 40. The processing unit 30 is electrically connected to the smart audio processing unit 20 and adapted to receive the processed digital audio data and generate a sound stream according to the processed digital audio data.

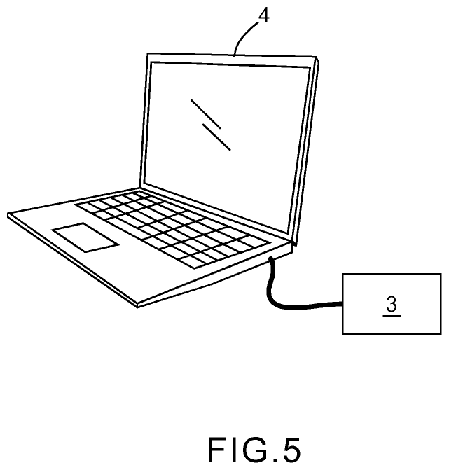

The port 40 is electrically connected to the processing unit 30 and adapted to allow the smart audio noise reduction system 3 to be electrically connected to an electronic device 4 via the port 40, thereby providing the sound stream to the electronic device 4, as shown in FIG. 5. Therefore, the smart audio noise reduction system 3 can operate in conjunction with different electronic devices in a flexible manner, thereby enhancing the ease of use and configuration of the smart audio noise reduction system 3.

In an embodiment, the processing unit 30 is implemented by a digital circuit comprising a digital signal processor, but the present disclosure is not limited thereto.

In an embodiment, the port 40 is a transmission interface which complies with a USB standard, but the present disclosure is not limited thereto.

In an embodiment, the electronic device 2 and the electronic device 4 are each a personal computer, a laptop, a tablet or a smartphone electronic device, but the present disclosure is not limited thereto.

Therefore, when recording audio, a user can use the smart audio noise reduction system 1 to obtain a sound stream of definite voice data falling within a specific range of angles without accessing any other apparatuses or signal processing processes.

Therefore, the smart audio noise reduction system 1 comprises a smart audio processing unit 20 capable of recognizing voice data in audio data with an artificial intelligence algorithm and processing audio data to highlight the voice data in the audio data falling within a specific range of angles, such that the user can easily obtain a sound stream of definite voice data, thereby enhancing the ease of collecting the voice data falling within a specific range of angles.

While the present disclosure has been described by means of specific embodiments, numerous modifications and variations could be made thereto by those skilled in the art without departing from the scope and spirit of the present disclosure set forth in the claims.

What is claimed is:

1. A smart audio noise reduction system, comprising:
sound-receiving units for receiving audio to generate an audio data; and
a smart audio processing unit electrically connected to the sound-receiving units and adapted to receive the audio data, recognize voice data in the audio data with an artificial intelligence algorithm, generate processed digital audio data of the voice data falling within a specific range of angles, and send the processed digital audio data to an electronic device.

2. The smart audio noise reduction system of claim 1, wherein the smart audio processing unit comprises a trained artificial intelligence algorithm for recognizing the voice data of the audio data.

3. The smart audio noise reduction system of claim 1, wherein the smart audio processing unit reduces or deletes audio data outside the specific range of angles according to the identified voice data within the specific range of angles.

4. The smart audio noise reduction system of claim 1, wherein the specific range of angles depends on a distance between the sound-receiving units.

5. The smart audio noise reduction system of claim 1, wherein the sound-receiving units are each a digital microphone.

6. The smart audio noise reduction system of claim 1, wherein the electronic device is a personal computer, a laptop, a tablet or a smartphone.
